(19) United States
(12) Patent Application Publication
(10) Pub. No.: US 2025/0042206 A1
(43) Pub. Date: Feb. 6, 2025

(54) LIFTING SYSTEM AND METHODS OF USE THEREOF

(71) Applicant: The Coats Company, LLC, LaVergne, TN (US)

(72) Inventor: Andrew Freeman, Hermitage, TN (US)

(21) Appl. No.: 18/791,426

(22) Filed: Aug. 1, 2024

Related U.S. Application Data
(60) Provisional application No. 63/517,102, filed on Aug. 1, 2023.

(51) Int. Cl. B60C 25/05; B60C 25/138

(52) U.S. Cl. CPC B60C 25/0521; B60C 25/138

(57) ABSTRACT

A lifting system operably associable with a tire changing machine having a rotatable wheel holder and an arm, the arm having an implement disposed at a distal end thereof. The lifting system comprising first and second selectively extendable actuators configured for placement below the rotatable wheel holder of the tire changing machine and a controller communicatively coupled to the first and second actuators. When the lifting system is operably associated with the tire changing machine having a wheel mounted to the rotatable wheel holder and a tire disposed about the wheel, the controller is configured to extend the first actuator such that at least a portion of the tire is lifted relative to the wheel and the implement of the tire changing machine engages at least a portion of the tire.

### CROSS-REFERENCES TO RELATED APPLICATIONS

This application claims benefit of the following patent application which is hereby incorporated by reference: U.S. Provisional Application No. 63/517,102 filed Aug. 1, 2023, entitled “Leverless Assist Device and Methods of Use Thereof”

### BACKGROUND

### 1. Field of Invention

The present invention relates generally to a system for use with a tire changing machine. More particularly, this invention relates to a lifting system for manipulating a tire relative to a wheel to assist an operator using a lever-less tire changing machine.

### 2. Description of the Prior Art

Leverless tire changing machines of the type disclosed in U.S. Pat. Nos. 7,743,812 and 9,139,055 are generally known in the prior art. An exemplary embodiment of a prior art leverless tire changing machine is shown in FIGS. 1 and 2 and generally referred to by the number 100. Leverless tire changing machines 100 may include a chassis 110, a rotatable wheel holder 120 mounted on the chassis 110, and an arm 130 mounted to the chassis 110 and having an implement 140 disposed at a distal end thereof. In some embodiments, the arm 130 may be rotatably coupled to the chassis 110. The implement 140 may be operable in an extended position and a retracted position. When a wheel and tire assembly 150 is mounted to the rotatable wheel holder 120 and the implement 140 is in the extended configuration, the implement 140 may be positioned between a flange 156 of the wheel 152 and the corresponding tire 154. Once the implement 140 engages the tire 154, the implement 140 may be moved to the retracted position wherein the implement 140 pulls a bead 158 of the tire 154 over the flange 156 of the wheel 152 for removal of the tire 154.

During such use, an operator of the leverless tire changing machine 100 may position the wheel and tire assembly 150 on the rotatable wheel holder 120 or the like to secure the wheel and tire assembly 150 to the leverless tire changing machine 100. The rotatable wheel holder 120 may engage and selectively rotate the wheel 152 and/or tire 154. Often, the wheel and tire assembly 150 is selected such that the width of the tire 154 is narrower than the width of the wheel 152. When the wheel and tire assembly 150 is positioned on the rotatable wheel holder 120, an unpressurized tire 154 may sag due to the effects of gravity. This creates a gap between the upper flange 156 of the wheel 152 and the tire 154, as shown in FIG. 2. One drawback of prior art leverless tire changing machines 100 is the limited reach of the implement 120. Often, the implement 120 in the extended position is unable to extend far enough below the wheel flange 156 to overcome the gap and engage the tire 154. Further, the distance the implement 120 extends is limited by the size of the wheel 152. If the implement 120 extends too far, the implement 120 may cause damage to the tire pressure monitoring system and wheel surfaces, or the function of the implement 120 may be sacrificed resulting in sub-optimal effectiveness.

To overcome this drawback, it is necessary for the operator to manually manipulate the tire 154 to engage the implement 120 when the implement 120 is extended, as shown in FIG. 3. This manipulation can occur either by direct contact of the operator (e.g., the operator lifts up on the tire 154), or by use of a tire bar operated by the operator (e.g., the operator leverages a tire bar to contact the tire 154 and lift up the tire 154). Both of these operations create a safety hazard for the operator wherein the operator's hands may be in areas with a significant risk of being pinched or injured, or the tire bar may become jammed or put under tension resulting in the operator losing control of the tire bar and becoming injured. Further, the tire bar can damage the tire 154 and/or the wheel 152 if used improperly. Moreover, manual manipulation by the operator may decrease throughput and efficiency as removal times of the tire 154 increase when the operator has to manipulate the tire 154.

Accordingly, a need exists for improvements in leverless tire changing machines 100. Specifically, what is needed is a system or device to assist the operator of a leverless tire changing machine 100 that is universally operable with both low profile and high aspect ratio side wall tires 154. The system or device may no longer require manual manipulation of the tire 154 by an operator, or the use of a tire bar, to engage the tire 154 for dismounting, thereby reducing the likelihood of injury.

### BRIEF SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

One aspect in accordance with the present disclosure is a lifting system operably associable with a tire changing machine having a rotatable wheel holder and an arm. The arm may have an implement disposed at a distal end thereof. The lifting system may comprise first and second selectively extendable actuators configured for placement below the rotatable wheel holder of the tire changing machine and a controller communicatively coupled to the first and second actuators. When the lifting system is operably associated with the tire changing machine having a wheel mounted to the rotatable wheel holder and a tire disposed about the wheel, the controller may be configured to extend the first actuator such that at least a portion of the tire is lifted relative to the wheel and the implement of the tire changing machine may selectively engage at least a portion of the tire.

In accordance with other aspects of the present disclosure, the controller may be configured to extend the second actuator such that at least a portion of the tire is lifted relative to the wheel.

In accordance with other aspects of the present disclosure, the portion of the tire the first actuator is configured to engage is substantially diametrically opposite of the portion of the tire the second actuator is configured to engage.

In accordance with other aspects of the present disclosure, the controller is configured to extend the second actuator such that at least a portion of the tire is lifted relative to the wheel before extending the first actuator.

In accordance with other aspects of the present disclosure, the controller is configured to retract the second actuator such that the second actuator no longer engages the tire after the implement of the tire changing machine engages at least a portion of the tire.

In accordance with other aspects of the present disclosure, the implement is configured to decouple at least a portion of the tire from the wheel while the first actuator is extended such that at least a portion of the tire is lifted relative to the wheel.

In accordance with other aspects of the present disclosure, the lifting system may further comprise one or more sensors communicatively coupled to the controller. The one or more sensors may be configured to at least detect a position of a one of the first and second actuators relative to the tire and/or wheel.

In accordance with other aspects of the present disclosure, the lifting system may further comprise one or more sensors communicatively coupled to the controller. The one or more sensors may be configured to at least detect a position of the implement relative to the tire and/or wheel.

In accordance with other aspects of the present disclosure, when the lifting system is operably associated with the tire changing machine, the first actuator may be substantially colinear to the implement.

In accordance with other aspects of the disclosure, when the lifting system is operably associated with the tire changing machine, the first and second actuators may be mounted to a chassis of the tire changing machine.

In accordance with other aspects of the disclosure, when the lifting system is operably associated with the tire changing machine, the first and second actuators may be mounted to a substantially flat surface separate from the tire changing machine.

Another aspect in accordance with the present disclosure is a method of manipulating a tire relative to a wheel wherein the wheel is mounted to a rotatable wheel assembly of a tire changing machine. The tire changing machine may include an arm having an implement disposed at a distal end thereof. The method may comprise providing a lifting system operably associable with the tire changing machine. The lifting system may include first and second selectively extendable actuators and a controller communicatively coupled to the first and second actuators. The first and second actuators may be configured for placement below the rotatable wheel holder of the tire changing machine. The method may further comprise extending the first actuator such that at least a portion of the tire is lifted relative to the wheel and the implement of the tire changing machine may selectively engage at least a portion of the tire.

In accordance with other aspects of the disclosure, the method may further comprise extending the second actuator such that at least a portion of the tire is lifted relative to the wheel.

In accordance with other aspects of the disclosure, the portion of the tire the first actuator is configured to engage is substantially diametrically opposite of the portion of the tire the second actuator is configured to engage.

In accordance with other aspects of the disclosure, the method further comprises retracting the second actuator such that the second actuator no longer engages the tire.

In accordance with other aspects of the disclosure, the method further comprises, via the implement, decoupling at least a portion of the tire from the wheel while the first actuator is extended such that at least a portion of the tire is lifted relative to the wheel.

In accordance with other aspects of the disclosure, the method further comprises, via one or more sensors communicatively coupled to the controller, detecting a position of a one of the first and second actuators relative to the tire and/or wheel.

In accordance with other aspects of the disclosure, the method further comprises, via one or more sensors communicatively coupled to the controller, detecting a position of the implement relative to the tire and/or wheel.

In accordance with other aspects of the disclosure, when the lifting device is operably associated with the tire changing machine, the first actuator is substantially colinear to the implement.

Numerous objects, features and advantages of the present invention will be readily apparent to those skilled in the art upon a review of the following description in conjunction with the accompanying drawings.

### BRIEF DESCRIPTION OF THE DRAWINGS

FIG. 1 is a perspective view of a prior art leverless tire changing machine.

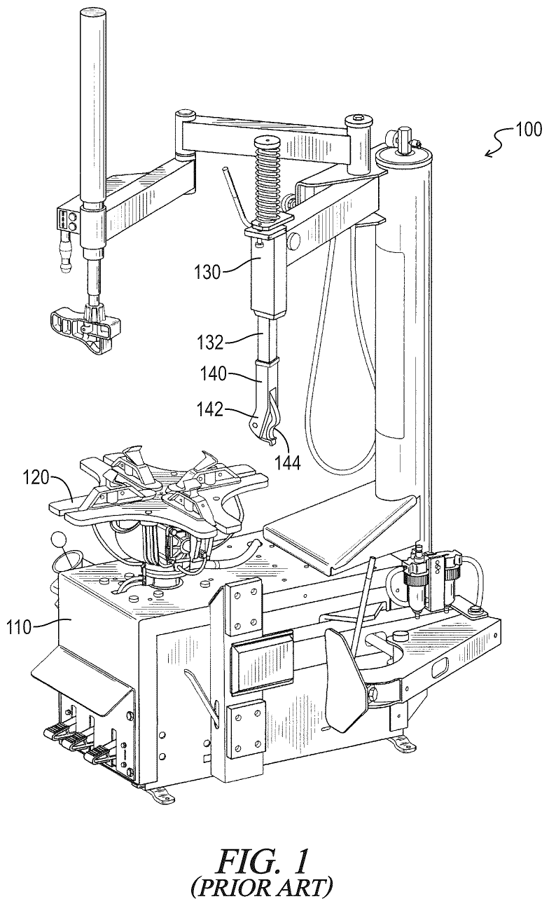

FIG. 2 is a cross-sectional view of the prior art leverless tire changing machine of FIG. 1 wherein a wheel and tire assembly is mounted thereto.

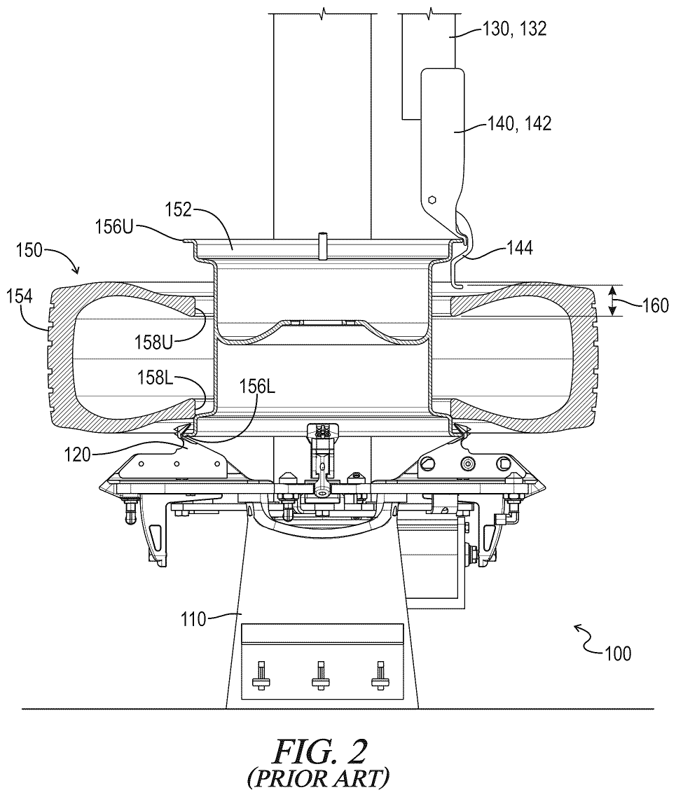

FIG. 3 is a cross-sectional view of the prior art leverless tire changing machine of FIG. 1 wherein the wheel and tire assembly is lifted by an operator.

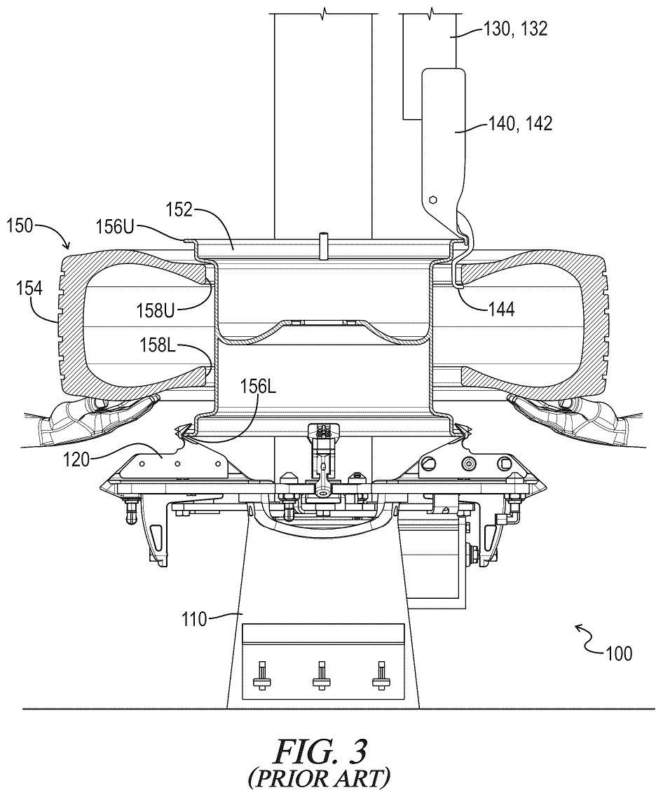

FIG. 4 is a cross-sectional view of an exemplary embodiment of a lifting system in accordance with the present disclosure wherein the lifting system is associated with the leverless tire changing machine of FIG. 1.

FIG. 5 is a cross-sectional view of an exemplary embodiment of a lifting system in accordance with the present disclosure wherein the lifting system is associated with the leverless tire changing machine of FIG. 1.

FIG. 6 is a cross-sectional view of the lifting system of FIG. 5 wherein the tire is partially lifted by an actuator.

FIG. 7 is a cross-sectional view of the lifting system of FIG. 5 wherein an engagement member of an implement of the leverless tire changing machine of FIG. 1 is in an extended position.

FIG. 8 is a cross-sectional view of the lifting system of FIG. 5 wherein the tire is lifted by a pair of actuators and the engagement member of the implement of the leverless tire changing machine of FIG. 1 engages the tire.

FIG. 9 is a cross-sectional view of the lifting system of FIG. 5 wherein one of the pair of actuators is retracted such that it no longer lifts the tire.

FIG. 10 is a cross-sectional view of the lifting system of FIG. 5 wherein an upper bead of the tire is pulled over an upper flange of the wheel by the implement of the leverless tire changing machine of FIG. 1.

FIG. 11 is a schematic view of a controller of the lifting system of FIG. 5.

FIG. 12 is a schematic view of a control system of the lifting system of FIG. 5.

### DETAILED DESCRIPTION

Reference will now be made in detail to embodiments of the present disclosure, one or more drawings of which are set forth therein. Each drawing is provided by way of explanation of the present disclosure and is not a limitation. In fact, it will be apparent to those skilled in the art that various modifications and variations can be made to the teachings of the present disclosure without departing from the scope of the disclosure. For instance, features illustrated or described as part of one embodiment can be used with another embodiment to yield a still further embodiment.

Thus, it is intended that the present disclosure covers such modifications and variations as come within the scope of the appended claims and their equivalents. Other objects, features, and aspects of the present disclosure are disclosed in, or are obvious from, the following detailed description. It is to be understood by one of ordinary skill in the art that the present discussion is a description of exemplary embodiments only and is not intended as limiting the broader aspects of the present disclosure.

The words “connected,” “attached,” “joined,” “mounted,” “fastened,” and the like should be interpreted to mean any manner of joining two objects including, but not limited to, the use of any fasteners such as screws, nuts and bolts, bolts, pin and clevis, and the like allowing for a stationary, translatable, or pivotable relationship; welding of any kind such as traditional MIG welding, TIG welding, friction welding, brazing, soldering, ultrasonic welding, torch welding, inductive welding, and the like; using any resin, glue, epoxy, and the like; being integrally formed as a single part together; any mechanical fit such as a friction fit, interference fit, slidable fit, rotatable fit, pivotable fit, and the like; any combination thereof; and the like.

Unless specifically stated otherwise, any part of the apparatus of the present disclosure may be made of any appropriate or suitable material including, but not limited to, metal, alloy, polymer, polymer mixture, wood, composite, or any combination thereof. Furthermore, any part of the apparatus of the present disclosure may be made using any applicable manufacturing method, such as, but not limited to 3D printing, injection molding, or the like.

To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995). Also, to the extent that the terms “in” or “into” are used in the specification or the claims, it is intended to additionally mean “on” or “onto.” Furthermore, to the extent the term “connect” is used in the specification or claims, it is intended to mean not only “directly connected to,” but also “indirectly connected to” such as connected through another component or multiple components.

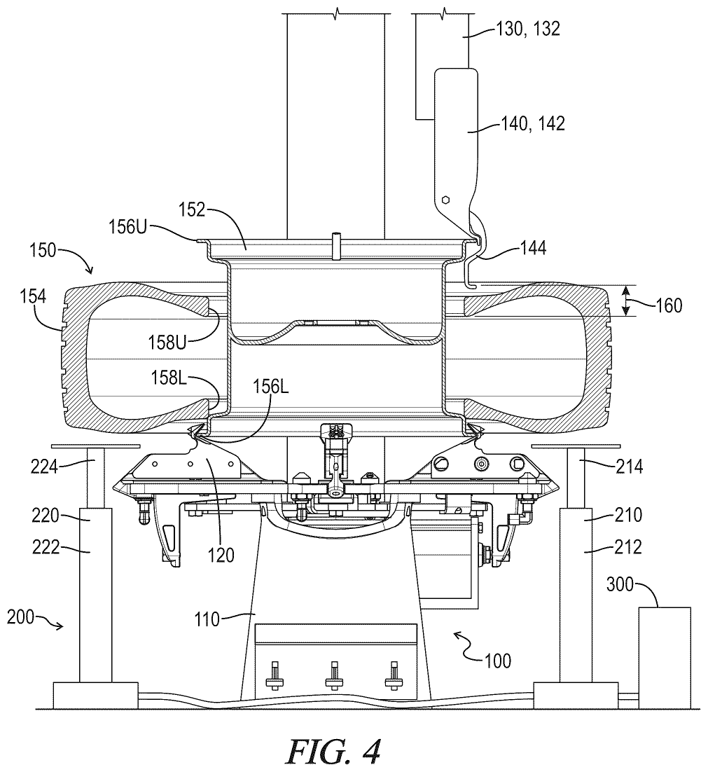

Referring now to the figures, and specifically FIGS. 4-10, an embodiment of a lifting system is shown and generally referred to as number 200. The lifting system 200 may be operably associable with a tire changing machine, such as the leverless tire changing machine 100. The lifting system 200 may be integral to the leverless tire changing machine 100, or alternatively may be added/coupled to an existing leverless tire changing machine 100. The leverless tire changing machine 100 may be operable to dismount a tire 154 from a wheel 152 and the lifting system 200 may minimize the amount of operator intervention required.

The leverless tire changing machine 100 may include a chassis 110, a rotatable wheel holder 120 mounted on the chassis 110, and an arm 130 mounted to the chassis 110. The arm 130 may have a vertical portion 132 and an implement 140 disposed at a distal end of the vertical portion 132. In accordance with certain aspects of the disclosure, the implement 140 may be a hook or similar member. The vertical portion 132 may be selectively extendable such that the implement 140 may be lowered and raised relative to the chassis 110. In certain optional embodiments, the arm 130 may be rotatably coupled to the chassis 110 such that the vertical portion 132 may be moved/rotated relative to the chassis 110. The vertical portion 132 may include an actuator, such as a hydraulic cylinder to name one example, that allows the vertical portion 132 to be selectively extendable.

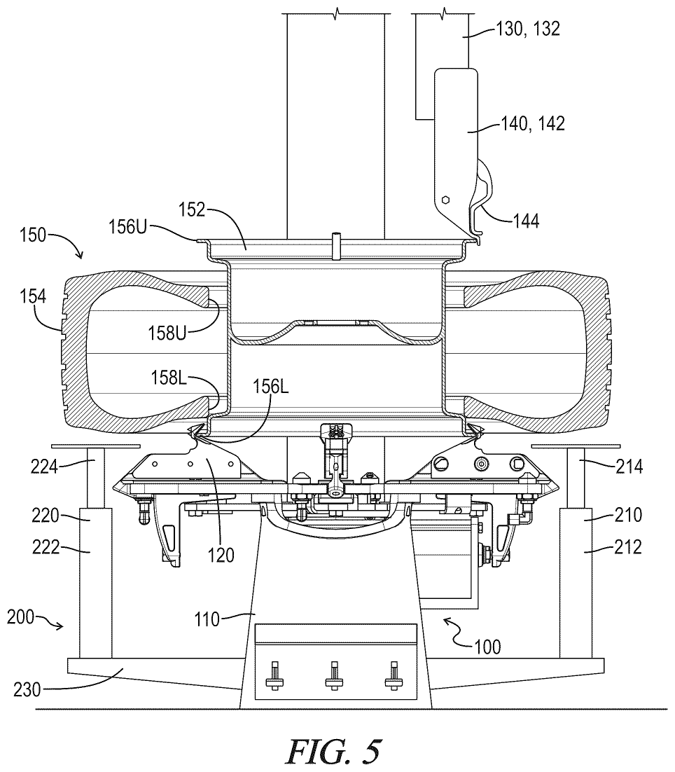

The implement 140 may include a main body 142 and an engagement member 144. The implement 140 may be operable in an extended position and a retracted position. In the extended position, the engagement member 144 may extend relative to the main body 142. The implement 140 is in the extended position in FIGS. 4 and 7-9. In the retracted position, the engagement member 144 may be retracted back towards the main body 142. The implement 140 is in the retracted position in FIGS. 5-6 and 10. When a wheel and tire assembly 150 is mounted to the rotatable wheel holder 120 and the implement 140 is in the extended position, the engagement member 144 of the implement 140 may be positioned between a flange 156 of the wheel 152 and the corresponding tire 154. Once the implement 140, and more specifically the engagement member 144, engages the tire, the implement 140 may be moved to the retracted position wherein the engagement member 144 is retracted, thus pulling a bead 158 of the tire 154 over the flange 156 of the wheel 152 for removal of the tire 154.

Referring now to FIG. 4, in preparation for removing the tire 154 from the wheel 152, an operator may mount and secure the wheel and tire assembly 150 to the rotatable wheel holder 120 of the leverless tire changing machine 100. The wheel 152 may have an upper flange 156U and a lower flange 156L when mounted to the rotatable wheel holder 20. The tire 154 may have an upper bead 158U and a lower bead 158L when disposed about the wheel 152 mounted to the rotatable wheel holder 120. The upper bead 158U and lower bead 158L of the tire 154 may be decoupled from the upper flange 156U and lower flange 156L of the wheel 152, respectively. The tire 154 may then be loosely disposed about the wheel 152. Due to gravity, the tire 154, and specifically the upper bead 158U, may sag relative to the wheel 152. Thus, a gap 160 may exist between the upper flange 156U of the wheel 152 and the upper bead 158U of the tire 154.

In certain optional embodiments, the lifting system 200 may include a first actuator 210 and a second actuator 220. Each of the first and second actuators 210, 220 may be selectively extendable and be a pneumatic, hydraulic, electric, mechanical, or other appropriate type of mechanism. The first and second actuators 210, 220 may be configured for placement below the rotatable wheel holder 120 of the leverless tire changing machine 100. In certain optional embodiments as shown in FIG. 4, the first and second actuators 210, 220 may be supported by and/or mounted to a substantially flat surface to which the leverless tire changing machine 100 is supported by and/or mounted to. In other optional embodiments, the first and second actuators 210, 220 may be supported by and/or mounted to the chassis 110 or other portion of the leverless tire changing machine 100. In other optional embodiments as shown in FIGS. 5-10, the first and second actuators 210, 220 may be supported by and/or mounted to a chassis 230.

Each of the first and second actuators 210, 220 may be configured to extend and contact a tire 154 of a wheel and tire assembly 150 mounted on the rotatable wheel holder 120. The first and second actuators 210, 220 may be configured to lift the tire 154 a given distance relative to the corresponding wheel 152. Similarly, the first and second actuators 210, 220 may be configured to retract and lower the tire 154 a given distance relative to the corresponding wheel 152.

In certain optional embodiments, each of the first and second actuators 210, 220 may include a cylinder body 212, 222 which houses a piston 214, 224 that can be actuated pneumatically or hydraulically. In other optional embodiments, the piston 214, 224 may be mechanically or electrically driven. The piston 214, 224 may be configured to contact the tire 154 itself, or the piston may be connected to and move another member which may contact the tire 154. In certain optional embodiments, the piston 214, 224 may be connected to a roller that is operable to contact the tire 154, but allow for the tire 154 to be rotated about the rotatable wheel holder 120 with minimal resistance from the actuator 210, 220. In certain optional embodiments, the actuator 210, 220 may be linked to a member by one or more linkages which act to move the member when the actuator 210, 220 is extended and/or retracted. These one or more linkages may be mechanical linkages, including, but not limited to, levers, two-bar linkages, three-bar linkages, four-bar linkages, or the like.

In certain optional embodiments, the first and second actuators 210, 220 may be operable to assist in the dismounting of a tire 154 from a wheel 152 using the leverless tire changing machine 100. The first actuator 210 may be positioned such that it contacts a radial portion of the tire 154 that is substantially the same as the radial portion of the tire the implement 140 contacts. In certain optional embodiments, the first actuator 210 may be positioned substantially below the implement 140 such that the first actuator 210 and the vertical portion 132 and/or implement 140 of the leverless tire changing machine are substantially colinear. The first actuator 210 may lift the portion of the tire 154 that is contacted by the implement 140. In certain optional embodiments, the implement 140, via the arm 130, may be moveable so as to allow the operator to position the first actuator 210 opposite the implement 140. The first actuator 210 may be moveable so as to allow the operator to position the first actuator 210 opposite the implement 140. In other optional embodiments, the first actuator 210 may be stationary or fixed.

The second actuator 220 may be moveable so as to allow the operator to position the second actuator 220 in a desirable position relative to the tire 154. In other optional embodiments, the second actuator 220 may be stationary or fixed. The first and second actuators 210, 220 may generally be on opposite sides relative to the tire 154 such that during operation, the first and second actuators 210, 220 act on generally opposite sides of the tire 154. In other words, the radial portion of the tire 154 the first actuator 210 is configured to engage is substantially diametrically opposite of the radial portion of the tire 154 the second actuator 220 is configured to engage.

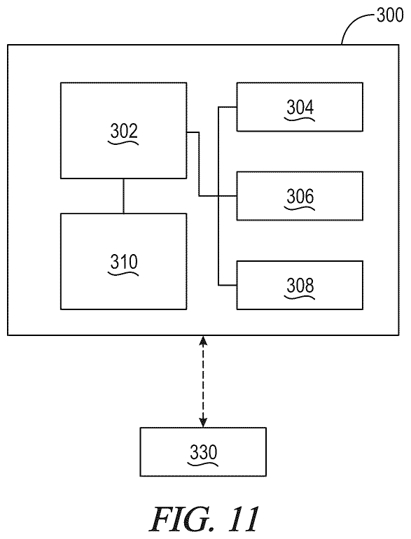

The lifting system 200 may include a controller 300, as shown in FIG. 11. The controller 300 may be configured to control the first and second actuators 210, 220 and/or the leverless tire changing machine 100. The controller 300 may include or be associated with a processor 302, a computer readable medium 304, a communication unit 306, and a data storage 308 such as for example a database network. It is understood that the controller 300 may be a single controller having some or all of the described functionality, or it may include multiple controllers wherein some or all of the described functionality is distributed among the multiple controllers. Some or all of the described functionality may for example be implemented using remote processing such as for example in a cloud server-based network. The leverless tire changing machine 100 may also include a resident controller. The resident controller of the leverless tire changing machine 100 may serve as or otherwise be associated with the controller 300.

Various operations, steps or algorithms as described in connection with the resident controller 300 can be embodied directly in hardware, in a computer program product such as a software module executed by the processor 302, or in a combination of the two. The computer program product can reside in RAM memory, flash memory, ROM memory, EPROM memory, EEPROM memory, registers, hard disk, a removable disk, or any other form of computer-readable medium 304 known in the art. An exemplary computer-readable medium 304 can be coupled to the processor 302 such that the processor 302 can read information from, and write information to, the memory/storage medium 304. In the alternative, the medium 304 can be integral to the processor 302. The processor 302 and the medium 304 can reside in an application specific integrated circuit (ASIC). The ASIC can reside in a user terminal. In the alternative, the processor 302 and the medium 304 can reside as discrete components in a user terminal.

The term “processor” 302 as used herein may refer to at least general-purpose or specific-purpose processing devices and/or logic as may be understood by one of skill in the art, including but not limited to a microprocessor, a microcontroller, a state machine, and the like. A processor 302 can also be implemented as a combination of computing devices, e.g., a combination of a DSP and a microprocessor, a plurality of microprocessors, one or more microprocessors in conjunction with a DSP core, or any other such configuration.

The communication unit 306 may support or provide communications between the resident controller 300 and external communications units, systems, or devices, and/or support or provide communication interface with respect to components of the leverless tire changing machine 100 and/or lifting system 200. The communication unit 306 may include wireless communication system components (e.g., via cellular modem, WiFi, Bluetooth or the like) and/or may include one or more wired communications terminals such as universal serial bus ports.

The data storage 308 may, unless otherwise stated, generally encompass hardware such as volatile or non-volatile storage devices, drives, electronic memory, and optical or other storage media, as well as in certain embodiments one or more databases residing thereon. In an optional embodiment, the data storage 308 may be configured to receive and retrievably store data sets, models, and/or algorithms, for further performing programmatic operations or the like as further disclosed herein.

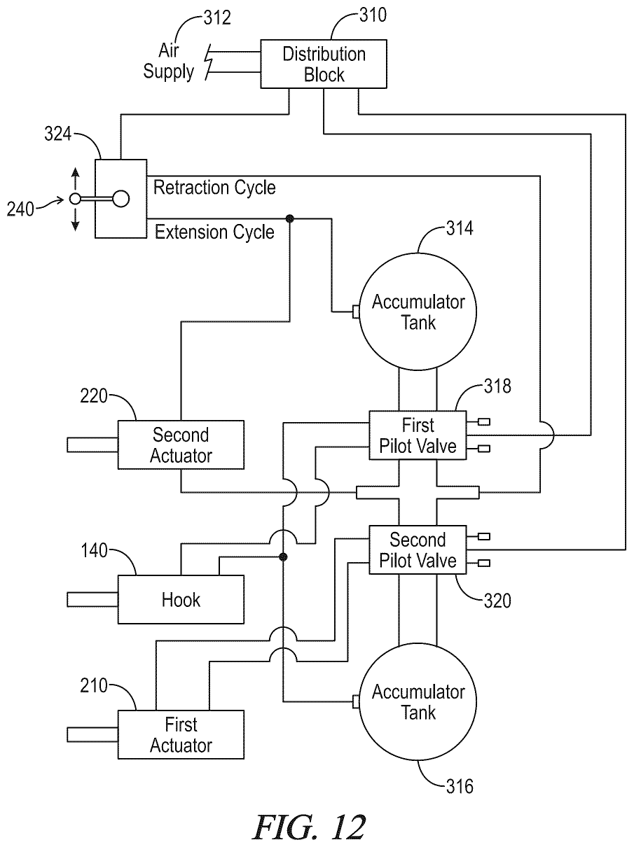

The operation of the leverless tire changing machine 100 and/or the lifting system 200 may be coordinated by the controller 300. As shown in FIG. 12, the controller 300 may be associated with a number of components, including but not limited to, a distribution block 310, air supply 312, accumulator tanks 314, 316, pilot valves 318, 320, mufflers, and various other components operatively connected to the controller 300. The controller 300 and various other associated components may form a control system or the like. The control system may be configured to coordinate the movement of the various systems and components associated with the leverless tire changing machine 100 and/or lifting device 200 to accomplish the demounting procedures for varying sizes and diameters of wheels 152 and tires 154 with reduced operation and/or input by the operator.

The controller 300 may be communicatively coupled to or otherwise associated with, either wirelessly or via a wired connection, the first and second actuators 210, 220. The controller 300 may be operable to transmit control signals to the first and second actuators 210, 220. Exemplary control signals may cause the first and/or second actuator 210, 220 to extend or retract.

The controller 300 may also be communicatively coupled to or otherwise associated with one or more sensors 330. The one or more sensors 330 may be configured to provide input data to the controller 300.

In certain optional embodiments, the one or more sensors 330 may be associated with the first and second actuators 210, 220. The one or more sensors 330 may be configured to at least detect a position of a one of the first and second actuators 210, 220 relative to the tire 154 and/or wheel 152. The one or more sensors 330 may detect an amount of extension of either or both of the first and second actuators 210, 220, the amount of extension of either or both of the first and second actuators 210, 220 once the respective actuator 210, 220 has contacted the tire 154, a distance the tire 154 has been lifted relative to the wheel 152, or other data associated with at least the wheel and tire assembly 150 and/or the first and second actuators 210, 220.

When each actuator 210, 220 is extended/retracted, forces may be generated in the form of pressure, rotational, applied, normal, or the like. The one or more sensors 330 may detect these forces which can be applied to adjust the action of action of the actuators 210, 220. In one exemplary scenario, the first actuator 210 may extend such that the first actuator 210 contacts the tire 154 and continues to extend until a predetermined threshold of back pressure is detected by the one or more sensors 330. The one or more sensors 330 may transmit signals reflecting the back pressure to the controller 300 and the controller 300 may cause the first actuator 210 to cease extending and/or retract. In another exemplary scenario, the one or more sensors 330 may detect travel of the piston 214 in relation to the cylinder body 222 and transmit signals reflecting the travel to the controller 300. The controller 300 may then determine a desirable distance of travel of the piston 214.

In certain optional embodiments, the one or more sensors 330 may be configured to at least detect a position of the implement 140 relative to the tire 154 and/or wheel 152. The one or more sensors 330 may a distance between the implement 140 and the tire 154, or more specifically a distance between the engagement member 144 of the implement 140 and the upper bead 158U of the tire 154. The one or more sensors 330 may detect when the implement 140 has engaged the tire 154 and/or when the implement 140 has removed at least a portion of the upper bead 158U of the tire 154 from the upper flange 156U of the wheel 152. The one or more sensors 330 may more generally detect the implement 140 as it moves relative to the wheel and tire assembly 150.

The one or more sensors 330 may include a reference location sensor that may be associated with the leverless tire changing machine 100 such that the reference location sensor transmits data to the controller 300 for determining the location of the implement 140 relative to the first actuator 210. By determining the position of the implement 140 relative to the wheel and tire assembly 150, the controller 300 may determine the appropriate position of the first actuator 210 relative to the implement 140.

Various control schemes may be contemplated, wherein the position of the first and second actuators 210, 220 may be manually set by the operator, determined by the controller 300 based on the position of the implement 140, preset based on the leverless tire changing machine 100 dimensions, or may be correlated by data based on the size of the wheel 152 and/or tire 154. Data for such positioning may include wheel 152 and/or tire 154 data and/or pre-defined control algorithms and routines to specific wheel 152 and tire 154 combinations. For example, the controller 300 may contain manufacturer data associated with specific wheels 152 and/or tires 154.

The lifting system 200 may include an input selector 240 that is communicatively connected to or otherwise associated with, either wirelessly or via a wired connection, the controller 300. The input selector 240 may be configured to receive operator input associated with the leverless tire changing machine 100 and/or the lifting system 200. The input selector 240 may include a switch, lever, knob, button, touchscreen, key, pushbutton, or the like. In one optional embodiment, the input selector 240 may include a foot actuated pedal. The input selector 240 may be a single input selector or alternatively a plurality of coordinated input selectors.

The control system associated with the lifting system 200 may include a main control valve 324 which may start an extension and retraction cycle of the lifting device 200. The input selector 240 may be moved to a first position which starts the extension cycle. At the start of the extension cycle, the second actuator 220 may be extended to raise a portion of the tire, specifically a contralateral portion of the tire relative to the implement 140. A first accumulator tank 314 may delay the activation of a first pilot valve 318 which moves the implement 140 into the extended position wherein the engagement member 144 is extended relative to the main body 142. Because of the use of the first accumulator tank 314, the implement 140 may be moved to the extended position after the second actuator 220 is extended. Simultaneously, a second accumulator tank 316 may delay activation of a second pilot valve 320 which extends the first actuator 210. The second accumulator tank 316 may have a larger volume than the first accumulator tank 314 such that as the tanks are simultaneously filled at equal rates, the first actuator 210 is caused to extend after the implement 140 is moved into the extended position. Once the first actuator 210 is extended, the extension cycle may be complete.

The retraction cycle may be started by moving the input selector 240 to a second position. During the retraction cycle, a similar order of operations may be performed, but various actuators may be actuated in an opposite direction of the extension cycle. At the start of the retraction cycle, the second actuator 220 may be retracted to lower a portion of the tire, namely to contralateral portion of the tire relative to the implement 140. The first accumulator tank 314 may delay the activation of the first pilot valve 318 which moves the implement 140 to the retracted position. Again, because of the use of the first accumulator tank 314, the implement 140 is moved to the retracted position after the retraction of the second actuator 220. Simultaneously, the second accumulator tank 316 may delay activation of the second pilot valve 320 which retracts the first actuator 210. Because the second accumulator tank 316 may have a larger volume than the first accumulator tank 314, the first actuator 210 may be caused to retract after the implement 140 is moved into the retracted position. Once the first actuator 210 has been retracted, the retraction cycle may be complete. In certain optional embodiments, a single interaction with the input selector 240 may start the extension cycle and subsequently start the retraction cycle.

Referring now to FIG. 5, the lifting system 200 may be configured to, in association with the leverless tire changing machine 100, dismount a tire 154 from a wheel 152. An operator may place the wheel and tire assembly 150 on the rotatable wheel holder 120 of the leverless tire changing machine 100. The wheel 152 may be coupled to the rotatable wheel holder 120 and the tire 154 disposed about the wheel 152. The upper and lower beads 158U, 158L of the tire 154 may be decoupled (i.e., each respective bead dislodged from an associated flange) from the upper and lower flanges 156U, 156L of the wheel 152, respectively.

The implement 140 may be moved to a standby configuration wherein the implement 140 is positioned relative to the wheel 152. The main body 142 of the implement 140 may abut the upper flange 156U of the wheel 152. The implement 140 may be in the retracted position wherein the engagement member 144 is retracted into the main body 142. A gap 160 may exist between the engagement member 144 of the implement 140 and the upper bead 158U of the tire 154. The implement 140 is shown in the standby configuration in FIG. 5.

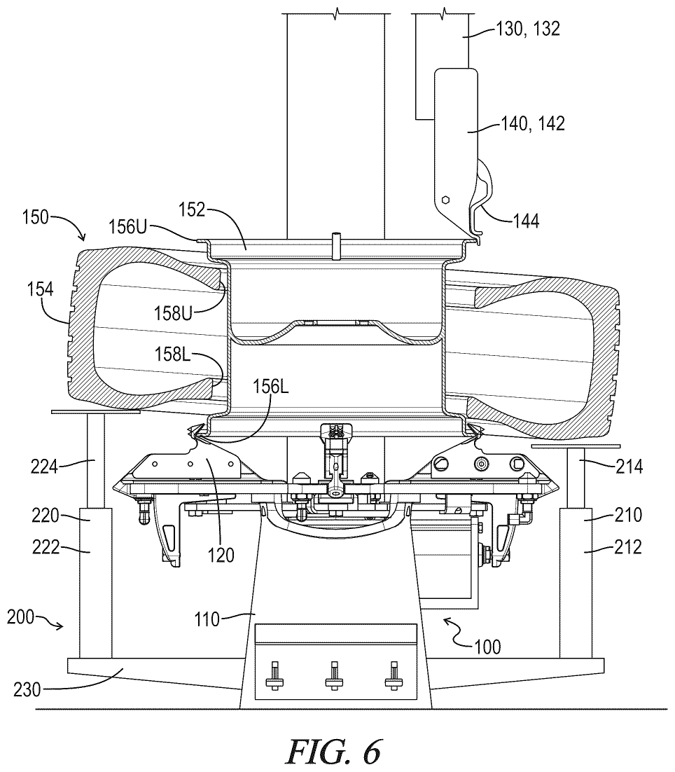

Referring now to FIG. 6, in certain optional embodiments, the operator may move the input selector 240 to a first position thereby causing the lifting system 200 and/or the leverless tire changing machine 100 to begin a demount/extension cycle. The second actuator 220 may extend and contact at least a portion of the tire 154 such that at least the portion of the tire 154 is lifted relative to the wheel 152. The portion of the tire 154 that the second actuator 220 is configured to engage may be substantially diametrically opposite of the portion of the tire 154 that the implement 140 is configured to engage. In other words, the second actuator 220 and the implement 140 may be located on opposite sides (separated by about 180 degrees) of the wheel and tire assembly 150. The second actuator 220 may extend such that the upper bead 158U of the portion of tire 154 engaged is lifted toward the upper flange 156U of the wheel 152. The second actuator 220 may then remain stationary and provide support to the tire 154.

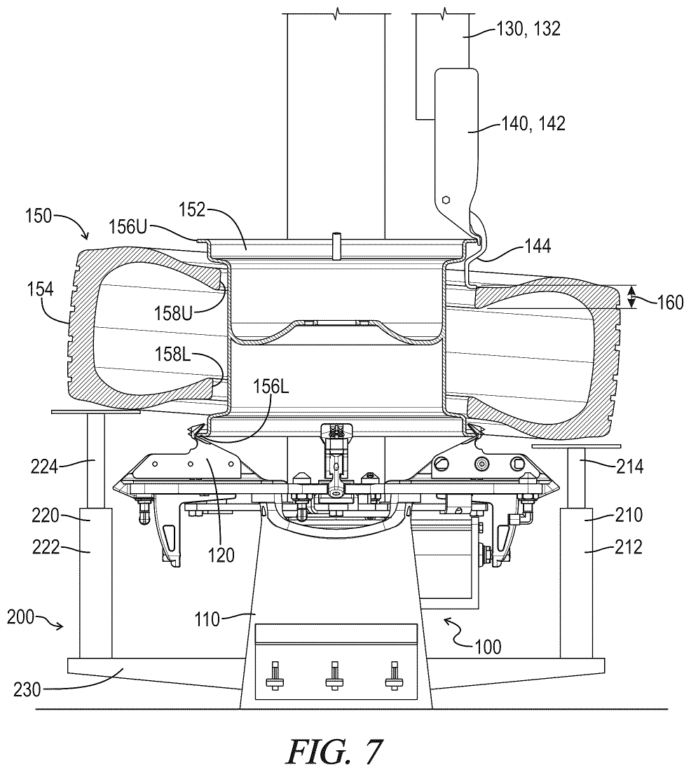

Referring now to FIG. 7, the implement 140 may then be moved into the extended position wherein the engagement member 144 is extended relative to the main body 142. The engagement member 144 may not reach the upper bead 158U of the tire 154 and thus be positioned above the upper bead 158U. A gap 160 may exist between the engagement member 144 and the upper bead 158U of the tire 154.

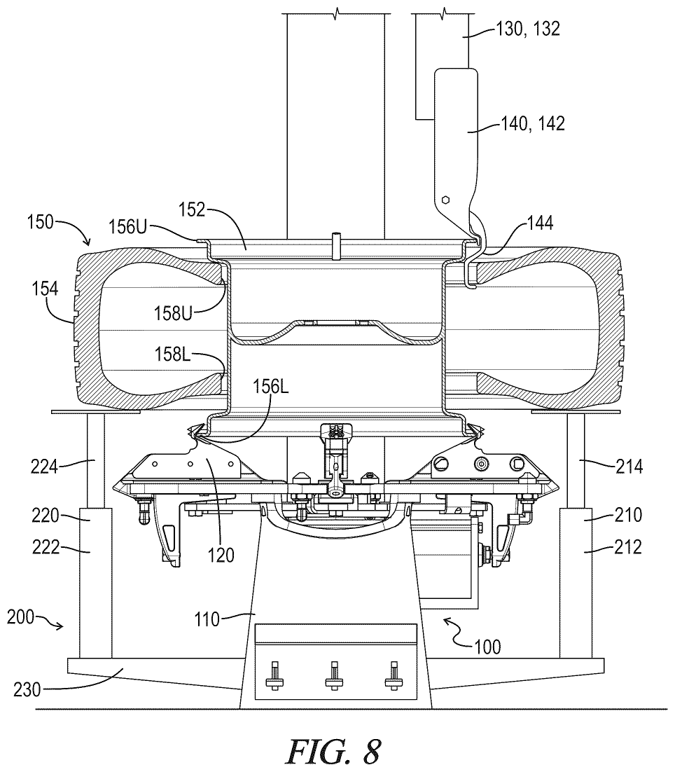

Referring now to FIG. 8, the first actuator 210 may extend and contact at least a portion of the tire 154 such that at least the portion of the tire 154 is lifted relative to the wheel 152 and the implement 140. More specifically, the first actuator 210 may be configured to lift the portion of the tire 154 that is substantially below the implement 140. This portion of the tire 154 may be opposite the portion lifted by the second actuator 220. The first actuator 210 may extend such that the upper bead 158U of the portion of tire 154 of the portion of the tire 154 engage is lifted toward the upper flange 156U of the wheel 152. The engagement member 144 of the implement 140 may slide under the upper bead 158U of the tire 154 as the tire 154 is lifted such that the engagement member 144 hooks the tire 154, thus allowing for manipulation of the tire 154 by the implement 140. The first actuator 210 may then remain stationary and provide support to the tire 154.

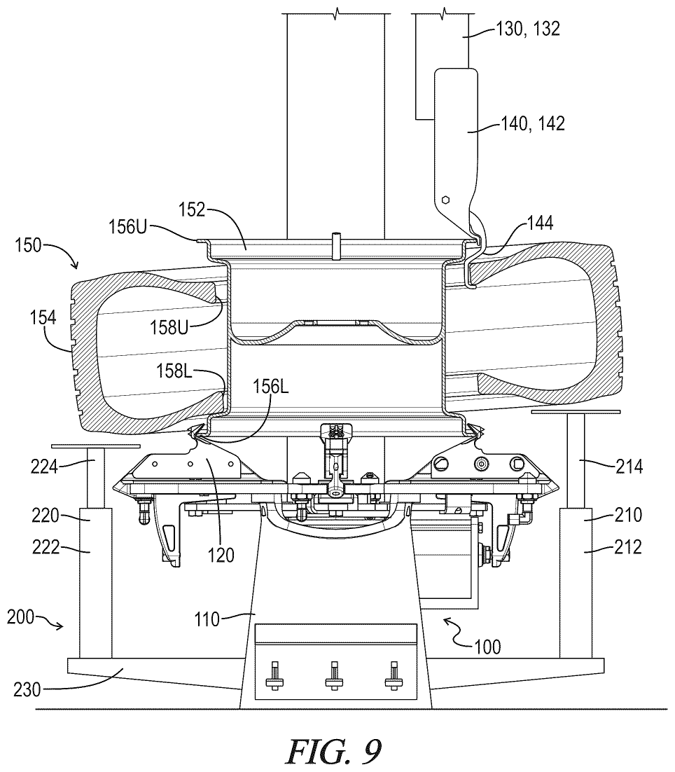

Referring now to FIG. 9, the second actuator 220 may retract such that the second actuator 220 no longer engages the tire 154. The second actuator 220 may retract after the implement 140 engages the tire 154. The portion of the tire 154 previously engaged by the second actuator 220 may sag or lower relative to the wheel 152, or may remain in place based on tension created by the implement 140. In certain optional embodiments, the first actuator 210 may also retract such that the first actuator 210 no longer engages the tire 154.

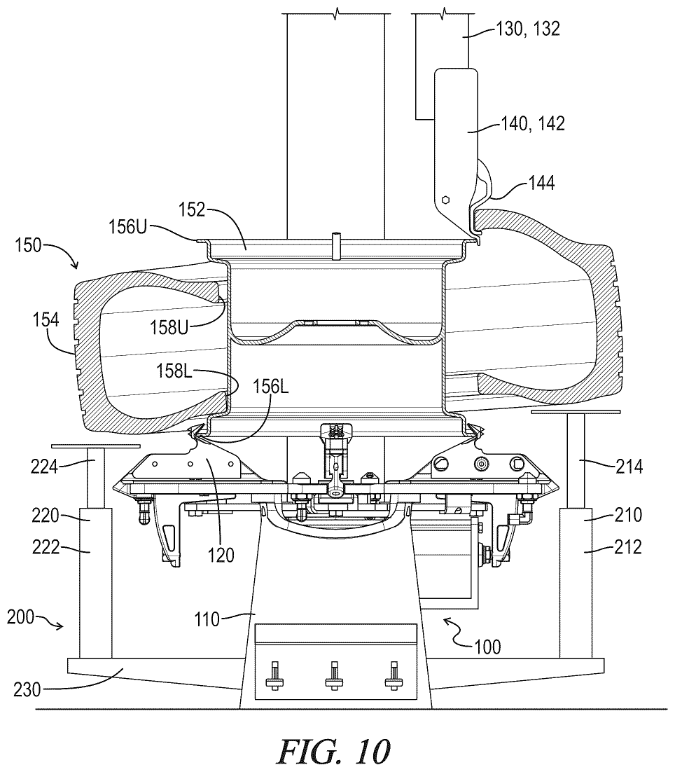

Referring now to FIG. 10, the implement 140 may be moved to the retracted position. Thus, the engagement member 144 may be retracted into the main body 142 of the implement 140. As the implement 140 retracts, the implement 140 may pull at least a portion of the upper bead 158U of the tire 154 over at least a portion of the upper flange 156U of the wheel 152.

The leverless tire changing machine 100 may then demount the tire 154 from the wheel 152. More specifically the rotatable wheel holder 120 may rotate such that both the wheel 152 and tire 154 rotate relative to the implement 140. As the rotatable wheel holder 120 rotates, the upper bead 158U of the tire 154 may become decoupled or dismounted from the upper flange 156U of the wheel 152. A similar process may be repeated to decouple or dismount the lower bead 158L of the tire 154 from the wheel 152.

In certain optional embodiments, the method of demounting the tire 154 from the wheel 152 may be timed in a pneumatic circuit such that activating the leverless tire changing machine 100, for example by manipulating the input selector 240, is the only operator intervention needed. In other optional embodiments, operator intervention may be needed throughout the demount process.

Thus, certain advantages of the lifting system 200 disclosed herein may be that it renders an associated leverless tire changing machine 100 universally compatible with both low profile and “floppy” sidewall tires 154. Another such advantage may be that the lifting system 200 does not require manual manipulation of the tire 154 or the use of a tire bar, thus preventing operator injury. Another such advantage may be that the lifting system 200 increases throughput and efficiency of an associated leverless tire changing machine 100.

Thus, it is seen that the apparatus and methods of the present disclosure readily achieve the ends and advantages mentioned as well as those inherent therein. While certain preferred embodiments of the disclosure have been illustrated and described for present purposes, numerous changes in the arrangement and construction of parts and steps may be made by those skilled in the art, which changes are encompassed within the scope and spirit of the present disclosure as defined by the appended claims. Each disclosed feature or embodiment may be combined with any of the other disclosed features or embodiments.

What is claimed is:

1. A lifting system operably associable with a tire changing machine having a rotatable wheel holder and an arm, the arm having an implement disposed at a distal end thereof, the lifting system comprising:
first and second selectively extendable actuators configured for placement below the rotatable wheel holder of the tire changing machine;
a controller communicatively coupled to the first and second actuators;
wherein when the lifting system is operably associated with the tire changing machine having a wheel mounted to the rotatable wheel holder and a tire disposed about the wheel, the controller is configured to:
extend the first actuator such that at least a portion of the tire is lifted relative to the wheel and the implement of the tire changing machine may selectively engage at least a portion of the tire.

2. The lifting system of claim 1, wherein:
the controller is configured to extend the second actuator such that at least a portion of the tire is lifted relative to the wheel.

3. The lifting system of claim 2, wherein:
the portion of the tire the first actuator is configured to engage is substantially diametrically opposite of the portion of the tire the second actuator is configured to engage.

4. The lifting system of claim 2, wherein:
the controller is configured to extend the second actuator such that at least a portion of the tire is lifted relative to the wheel before extending the first actuator.

5. The lifting system of claim 4, wherein:
the controller is configured to retract the second actuator such that the second actuator no longer engages the tire after the implement of the tire changing machine engages at least a portion of the tire.

6. The lifting system of claim 4, wherein:
the implement is configured to decouple at least a portion of the tire from the wheel while the first actuator is extended such that at least a portion of the tire is lifted relative to the wheel.

7. The lifting system of claim 1, further comprising:
one or more sensors communicatively coupled to the controller, the one or more sensors configured to at least detect a position of a one of the first and second actuators relative to the tire and/or wheel.

8. The lifting system of claim 1, further comprising:
one or more sensors communicatively coupled to the controller, the one or more sensors configured to at least detect a position of the implement relative to the tire and/or wheel.

9. The lifting system of claim 1, wherein:
when the lifting system is operably associated with the tire changing machine, the first actuator is substantially colinear to the implement.

10. The lifting system of claim 1, wherein:
when the lifting system is operably associated with the tire changing machine, the first and second actuators are mounted to a chassis of the tire changing machine.

11. The lifting system of claim 1, wherein:
when the lifting system is operably associated with the tire changing machine, the first and second actuators are mounted to a substantially flat surface separate from the tire changing machine.

12. A method of manipulating a tire relative to a wheel wherein the wheel is mounted to a rotatable wheel holder of a tire changing machine, the tire changing machine including an arm having an implement disposed at a distal end thereof, the method comprising:
providing a lifting system operably associable with the tire changing machine, the lifting system including first and second selectively extendable actuators and a controller communicatively coupled to the first and second actuators, the first and second actuators configured for placement below the rotatable wheel holder of the tire changing machine;
extending the first actuator such that at least a portion of the tire is lifted relative to the wheel and the implement of the tire changing machine may selectively engage at least a portion of the tire.

13. The method of claim 12, further comprising:
extending the second actuator such that at least a portion of the tire is lifted relative to the wheel.

14. The method of claim 13, wherein:
the portion of the tire the first actuator is configured to engage is substantially diametrically opposite of the portion of the tire the second actuator is configured to engage.

15. The method of claim 12, further comprising:
retracting the second actuator such that the second actuator no longer engages the tire.

16. The method of claim 12, further comprising:
via the implement, decoupling at least a portion of the tire from the wheel while the first actuator is extended such that at least a portion of the tire is lifted relative to the wheel.

17. The method of claim 12, further comprising:
via one or more sensors communicatively coupled the controller, detecting a position of a one of the first and second actuators relative to the tire and/or wheel.

18. The method of claim 12, further comprising:
via one or more sensors communicatively coupled to the controller, detecting a position of the implement relative to the tire and/or wheel.

19. The method of claim 12, wherein:
when the lifting system is operably associated with the tire changing machine, the first actuator is substantially colinear to the implement.
